(19) United States
(12) Patent Application Publication
(10) Pub. No.: US 2026/0196081 A1
(43) Pub. Date: Jul. 9, 2026

(54) FINGERPRINT AND NON-FINGERPRINT ENROLLMENT

(71) Applicant: Google LLC, Mountain View, CA (US)

(72) Inventors: Justin Douglas Eltoft, Pleasant Prairie, WI (US); Chien-Shang Lan, New Taipei City (TW)

(21) Appl. No.: 19/133,940

(22) PCT Filed: Dec. 19, 2022
(86) PCT No.: PCT/US2022/081968

§ 371 Date: May 29, 2025

(51) Int. Cl. G06V 40/50; G06F 21/32; G06V 40/12; G06V 40/13; G06V 40/60

(52) U.S. Cl. CPC G06V 40/50; G06F 21/32; G06V 40/1306; G06V 40/1365; G06V 40/67

(57) ABSTRACT

After authenticating a user, a computing device detects, by a fingerprint sensor, a touch input provided within a. predetermined period of time of the computing device authenticating the user. While detecting the touch input, the fingerprint sensor captures fingerprint information. The computing device determines whether the fingerprint information corresponds to any enrolled fingerprint from a set of enrolled fingerprints stored at the computing device. Responsive to determining that the fingerprint information does not correspond to any enrolled fingerprint from the set of enrolled fingerprints, the computing device stores the fingerprint information as an enrolled non-fingerprint.

### BACKGROUND

A computing device may include a touch or other presence sensor capable of detecting user input. For example, a computing device may include a presence-sensitive display capable of both displaying graphical objects and receiving user input to enable user interaction with the displayed graphical objects. Some example interactions include the user moving their finger across the presence-sensitive display to drag an object and/or cause the computing device to scroll. A computing device may also include a fingerprint sensor. In some examples, the computing device may require that a user place the user's finger at the fingerprint sensor as part of a fingerprint authentication process.

### SUMMARY

A computing device may use fingerprint information (e.g., one or more images) captured by a fingerprint sensor to passively enroll non-fingerprint portions of a user's hand. The computing device may use the enrolled non-fingerprint portions to determine if a fingerprint authentication attempt is intentional or unintentional. The computing device may not implement authentication safeguards (e.g., temporarily denying all authentication attempts) based on unintentional fingerprint authentication attempts because such attempts are likely accidents and may have even been initiated by the owner of the computing device. In this way, various aspects of the techniques may enable the computing device to avoid implementing, in response to unintentional fingerprint authentication attempts by the owner of the computing device, authentication safeguards that can result in considerable user frustration. Examples of such authentication safeguards may include fully locking the computing device (e.g., requiring an alternative authentication method, such as a password or an identifying number, to unlock the computing device), automatically wiping the computing device (e.g., rendering all data on the computing device unreadable), etc.

In some examples, a method includes: authenticating, by a computing device, a user of the computing device; detecting, by a fingerprint sensor of the computing device, a touch input provided within a predetermined period of time of the computing device authenticating the user; while detecting the touch input, capturing, by the fingerprint sensor, fingerprint information; determining, by the computing device, whether the fingerprint information corresponds to any enrolled fingerprint from a set of enrolled fingerprints stored at the computing device; and responsive to determining that the fingerprint information does not correspond to any enrolled fingerprint from the set of enrolled fingerprints, storing, by the computing device, the fingerprint information as an enrolled non-fingerprint.

In some examples, a computing device includes: a fingerprint sensor; one or more processors; a first memory configured to store fingerprint information; and a second memory that stores instructions that, when executed by the one or more processors, cause the one or more processors to: authenticate a user of the computing device; determine whether a touch input was detected by the fingerprint sensor within a predetermined period of time of the computing device authenticating the user; responsive to determining that the touch input was detected, determine whether fingerprint information captured by the fingerprint sensor while the fingerprint sensor detected the touch input corresponds to any enrolled fingerprint from a set of enrolled fingerprints stored in the first memory of the computing device; and responsive to determining that the fingerprint information does not correspond to any enrolled fingerprint from the set of enrolled fingerprints, store in the first memory of the computing device the fingerprint information as an enrolled non-fingerprint.

In some examples, a non-transitory computer-readable storage medium stores instructions that, when executed, cause one or more processors of a computing device to: authenticate a user of the computing device; determine whether a touch input was detected by the fingerprint sensor within a predetermined period of time of the computing device authenticating the user; responsive to determining that the touch input was detected, determine whether fingerprint information captured by the fingerprint sensor while the fingerprint sensor detected the touch input corresponds to any enrolled fingerprint from a set of enrolled fingerprints stored in a memory of the computing device; and responsive to determining that the fingerprint information does not correspond to any enrolled fingerprint from the set of enrolled fingerprints, store in the memory of the computing device the fingerprint information as an enrolled non-fingerprint.

In some examples, an apparatus includes: means for authenticating a user of the apparatus; means for detecting a touch input by the user, wherein the user provides the touch input within a predetermined period of time of authenticating the user; means for capturing, while detecting the touch input, fingerprint information; means for determining whether the fingerprint information corresponds to any enrolled fingerprint from a set of enrolled fingerprints stored at the computing device; and means for storing the fingerprint information as an enrolled non-fingerprint in response to determining that the fingerprint information does not correspond to any enrolled fingerprint from the set of enrolled fingerprints.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device in accordance with one or more aspects of the present disclosure.

FIG. 2 is a block diagram illustrating further details of a computing device in accordance with one or more techniques of this disclosure.

FIGS. 3A-3C are conceptual diagrams of various perspectives of a computing device in accordance with one or more techniques of this disclosure.

FIG. 4 is a flowchart illustrating example operations of an example computing device in accordance with one or more techniques of the present disclosure.

FIG. 5 is a flowchart illustrating example operations of an example computing device in accordance with one or more techniques of the present disclosure.

### DETAILED DESCRIPTION

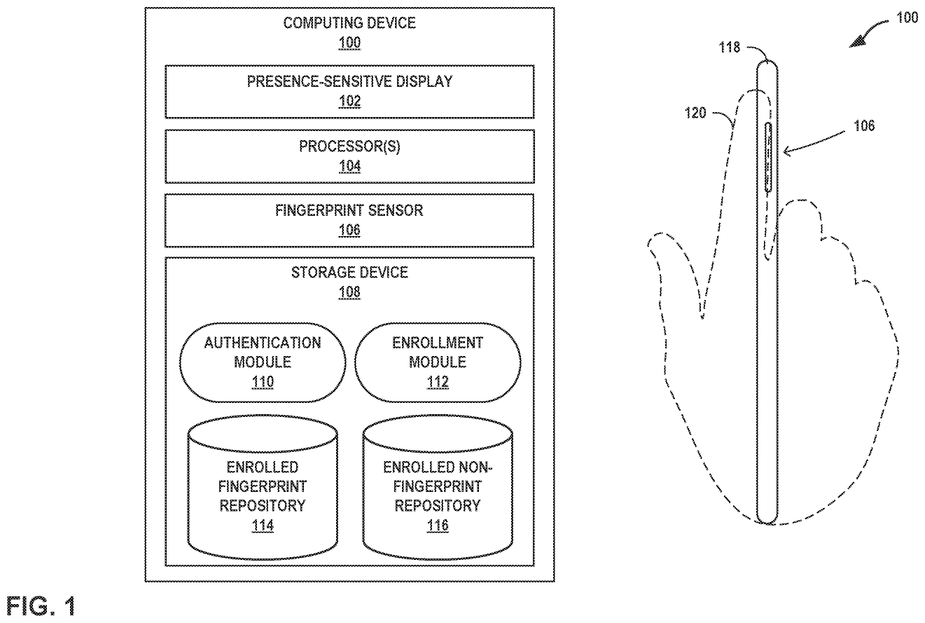

FIG. 1 is a conceptual diagram illustrating an example computing device 100. FIG. 1 illustrates only one particular example of computing device 100 and many other examples of computing device 100 may be used in other instances. In the example of FIG. 1, computing device 100 may be a wearable computing device, a mobile computing device, or any other computing device capable of receiving user input. Computing device 100 may include a subset of the components included in example computing device 100 of FIG. 1 or may include additional components not shown in FIG. 1.

In the example of FIG. 1, computing device 100 may be a mobile phone, such as a smartphone. However, computing device 100 may also be any other type of computing device such as a camera device, a tablet computer, a personal digital assistant (PDA), a laptop computer, a desktop computer, an e-book reader, or a wearable computing device (e.g., a computerized watch). As shown in FIG. 1, computing device 100 includes one or more presence-sensitive displays 102 (“presence-sensitive display 102”), one or more processors 104 (“processor 104”), one or more fingerprint sensors 106 (“fingerprint sensor 106”), and one or more storage devices 108 (“storage device 108”). As further shown in FIG. 1, storage device 108 may include an authentication module 110, an enrollment module 112, an enrolled fingerprint repository 114, and an enrolled non-fingerprint repository 116.

Presence-sensitive display 102 may function as a respective input and/or output device for computing device 100. Presence-sensitive display 102 may be implemented using various technologies. For instance, presence-sensitive display 102 may function as an input device using a presence-sensitive input screen, such as a capacitive touchscreen or projective capacitance touchscreen. Presence-sensitive display 102 may also function as an output (e.g., display) device using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 100. In the example of FIG. 1, presence-sensitive display 102 may be a presence-sensitive display capable of both receiving user input and displaying graphical data.

Processor 104 may implement functionality and/or execute instructions within computing device 100. Examples of processor 104 include, but are not limited to, one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein.

Computing device 100 may include fingerprint sensor 106. Fingerprint sensor 106 may be located at a portion (e.g., a front portion, a back portion, and/or one or more side portions) of a housing 118 of computing device 100. In various examples, fingerprint sensor 106 may be provided on the front portion of computing device 100 (e.g., underneath presence-sensitive display 102) and on one or more side portions of computing device 100 (e.g., as part of a solid-state button). In other examples, fingerprint sensor 106 may be provided on the back portion of computing device 100. In the example of FIG. 1, fingerprint sensor 106 is provided on the side portion of computing device 100.

Although fingerprint sensor 106 is primarily described herein as being located on the side portion of housing 118, fingerprint sensor 106 may additionally or alternatively be located at other portions of housing 118, such as the front portion and the rear portion of housing 118. Furthermore, although computing device 100 is primarily described herein as including one fingerprint sensor, computing device 100 may include multiple fingerprint sensors located at various portions of computing device 100, each of which may operate in accordance with techniques of this disclosure. In any case, fingerprint sensor 106 may capture fingerprint information (e.g., an image) representative of a portion of a hand (e.g., a finger) positioned at fingerprint sensor 106. The fingerprint information may be stored in a fingerprint information repository 114.

Storage device 108 may include one or more computer-readable storage media. For example, storage device 108 may be configured for long-term, as well as short-term storage of information, such as instructions, data, or other information used by computing device 100. In some examples, storage device 108 may include non-volatile storage elements. Examples of such non-volatile storage elements include magnetic hard disks, optical discs, solid state discs, and/or the like. In other examples, in place of, or in addition to the non-volatile storage elements, storage device 108 may include one or more so-called “temporary” memory devices, meaning that a primary purpose of these devices may not be long-term data storage. For example, the devices may comprise volatile memory devices, meaning that the devices may not maintain stored contents when the devices are not receiving power. Examples of volatile memory devices include random-access memories (RAM), dynamic random-access memories (DRAM), static random-access memories (SRAM), etc.

In general, computing device 100 may authenticate a user before allowing the user to unlock or otherwise access applications provided by computing device 100. While security is important, in some cases, a user may unintentionally initiate an authentication request. For example, the owner of computing device 100 may accidentally touch fingerprint sensor 106 while holding computing device 100, initiating an authentication request. If this unintended interaction results in a failed fingerprint authentication attempt too many times, computing device 100 may implement authentication safeguards against the owner of computing device 100 (e.g., temporarily deny all authentication requests). As used herein, a fingerprint authentication attempt may refer to any input detected by fingerprint sensor 106 that initiates an authentication request, whether the input was intended to be an authentication attempt or was an unintentional contact with fingerprint sensor 106 that was not intended to be an authentication attempt.

In accordance with techniques of this disclosure, enrollment module 112 of computing device 100 may passively enroll non-fingerprint portions of a hand of a user of computing device 100. As a result, computing device 100 may determine when a touch input 120 received at fingerprint sensor 106 is an enrolled non-fingerprint portion. In some examples, authentication module 110 of computing device 100 may not implement any authentication safeguards for any authentication attempt involving an enrolled non-fingerprint portion because such authentication attempts are likely unintended (e.g., an accidental byproduct of how the user is holding computing device 100). As a result, authentication module 110 may specifically implement authentication safeguards in response to unsuccessful intended fingerprint authentication attempts by people other than the owner of computing device 100. In this way, computing device 100 may provide important security measures without frustrating or inconveniencing the owner of computing device 100.

Before enrollment module 112 enrolls non-fingerprint portions of a hand of a user, authentication module 110 of computing device 100 may first authenticate a user of computing device 100. Authentication module 110 may authenticate the user of computing device 100 before computing device 100 enrolling non-fingerprint portions to, for example, confirm that the user currently operating computing device 100 is the owner of computing device 100. Authentication module 110 may authenticate the user of computing device 100 in a variety of ways, including using at least one of a password, an identifying number (e.g., a personal identification number (PIN)), fingerprint recognition, or facial recognition.

After authentication module 110 has authenticated the user of computing device 100, fingerprint sensor 106 may detect a touch input 120 by the user. While detecting touch input 120, fingerprint sensor 106 may capture or otherwise generate fingerprint information. The fingerprint information may be an image, a scan, and/or other information representative of touch input 120.

In general, touch input 120 may be by a fingerprint portion or a non-fingerprint portion of a user's hand. Touch input 120 may be by a fingerprint portion if touch input 120 is by a distal phalanx (e.g., the fingertip) of a user's finger. Touch input 120 may be by a non-fingerprint portion if touch input 120 is by another portion of the user's body, such as a proximal phalanx (e.g., the base) of a user's finger, an intermediate phalanx (e.g., the middle) of a user's finger, etc. Fingerprint information captured by fingerprint sensor 106 may include information representative of a fingerprint portion or information representative of a non-fingerprint portion depending on the portion of the user's body detected by fingerprint sensor 106.

Enrollment module 112 may obtain the fingerprint information captured by fingerprint sensor 106. In some examples, the user may need to provide touch input 120 to fingerprint sensor 106 within a predetermined period of time (e.g., 5 seconds, 15 seconds, 30 seconds, etc.) of authentication module 110 authenticating the user for enrollment module 112 to obtain the fingerprint information. The predetermined period of time may be selected such that it is unlikely for computing device 100 to change hands from the recently authenticated user to another person within the predetermined period of time. By limiting the amount of time during which non-fingerprint portions may be enrolled in this way, enrollment module 112 is more likely to enroll non-fingerprint portions of the hand of the recently authenticated user (e.g., the owner) of computing device 100 and not someone else's hand.

Enrollment module 112 may determine whether the fingerprint information captured by fingerprint sensor 106 corresponds to (e.g., matches) any enrolled fingerprint from a set of enrolled fingerprints stored in enrolled fingerprint repository 114. As used herein, a set may refer to zero or more elements. Accordingly, a set of enrolled fingerprints refers to zero or more enrolled fingerprints. Responsive to determining that the fingerprint information does not correspond to any enrolled fingerprint from the set of enrolled fingerprints, enrollment module 112 may determine that the fingerprint information includes information representative of a non-fingerprint portion and accordingly store the fingerprint information in enrolled non-fingerprint repository 116 as an enrolled non-fingerprint. Authentication module 110 may use the fingerprint information in enrolled fingerprint repository 114 and enrolled non-fingerprint repository 116 for future fingerprint authentication attempts.

In this way, the techniques of this disclosure may enable computing device 100 to avoid implementing authentication safeguards in response to accidental inputs from the owner of computing device 100, reducing user frustration. For example, computing device 100 may not fully lock computing device 100 (e.g., require an alternative authentication method, such as a password or a PIN, to unlock computing device 100), automatically wipe computing device 100 (e.g., render all data stored in the memory of computing device 100 unreadable), etc., in response to an unintended fingerprint authentication attempt. Additionally, the techniques of this disclosure may enable computing device 100 to operate more efficiently (e.g., in terms of processor cycles expended, memory consumed, memory bus bandwidth utilized, etc.) because implementing the authentication safeguards expends additional resources (e.g., processor cycles, memory space, memory bus bandwidth, etc.).

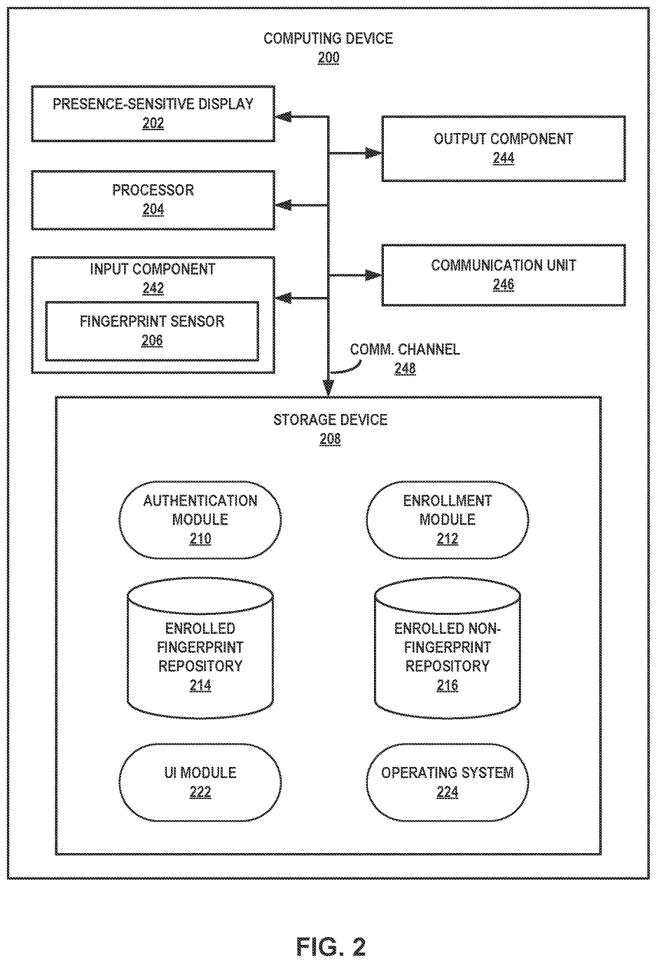

FIG. 2 is a block diagram illustrating further details of a computing device 200 in accordance with one or more techniques of this disclosure. Computing device 200 of FIG. 2 may be an example of computing device 100 illustrated in FIG. 1. FIG. 2 illustrates only one particular example of computing device 200, and many other examples of computing device 200 may be used in other instances and may include a subset of the components included in example computing device 200 or may include additional components not shown in FIG. 2.

As shown in FIG. 2, computing device 200 may include one or more presence-sensitive displays 202 (“presence-sensitive display 202”), one or more processors 204 (“processor 204”), one or more input components 242 (“input component 242”), one or more communication units 244 (“communication unit 244”), one or more output components 246 (output component 246″), and one or more storage devices 208 (“storage device 208”). As also shown in FIG. 2, storage device 208 may include an authentication module 210, an enrollment module 212, an enrolled fingerprint repository 214, an enrolled non-fingerprint repository 216, a user interface module 222 (“UI module 222”), and an operating system 224 (“OS 224”).

Presence-sensitive display 202 may detect input (e.g., touch and non-touch input) from a user of respective computing device 200. For instance, presence-sensitive display 202 may detect indications of input by detecting one or more gestures from a user (e.g., the user touching, pointing, and/or swiping at or near one or more locations of presence-sensitive display 202 with a finger, stylus pen, or another user input element). Presence-sensitive display 202 may output information to a user in the form of a user interface (UI), which may be associated with functionality provided by computing device 200. Such UIs may be associated with computing platforms, operating systems, applications, and/or services executing at or accessible from computing device 200 (e.g., electronic message applications, chat applications. Internet browser applications, mobile or desktop operating systems, social media applications, electronic games, menus, and other types of applications).

Presence-sensitive display 202 may allow one or more sensors to operate through presence-sensitive display 202. For instance, sensor signals and other external signals may pass through various layers of the presence-sensitive display 202 (making presence-sensitive display a “pass-through display”). To facilitate the pass-through nature of presence-sensitive display 202, various back coverings on presence-sensitive display 202 may be omitted during construction of presence-sensitive display 202 at locations above and/or adjacent to a location of fingerprint sensor 206 under presence-sensitive display 202. For example, presence-sensitive display 202 may include a back cover formed from foam (or other types of cushions) and copper (Cu) films that are removed in areas of the back cover above and/or adjacent to a location of fingerprint sensor 206. The omission of the back cover may allow the sensor signals and other external signals (e.g., light reflecting off a user's finger) to pass through presence-sensitive display 202.

In examples where fingerprint sensor 206 is a through-display fingerprint sensor, fingerprint sensor 206 may be underneath one or more layers of presence-sensitive display 202, such as a touchscreen layer of presence-sensitive display 202. In other words, fingerprint sensor 206 may be positioned within one or more of various layers of presence-sensitive display 202. Fingerprint sensor 206 may be configured to sense a fingerprint through presence-sensitive display 202.

Processor 204 may implement functionality and/or execute instructions within computing device 200. For example, processor 204 may receive and execute instructions that provide the functionality of authentication module 210, enrollment module 212, UI module 222, and OS 224. These instructions executed by processor 204 may cause computing device 200 to store and/or modify information within storage device 208 of processor 204 during program execution. Processor 204 may execute instructions of authentication module 210, enrollment module 212, UI module 222, and OS 224 to perform one or more operations. That is authentication module 210, enrollment module 212, UI module 222, and OS 224 may be operable by processor 204 to perform various functions described herein.

Storage device 208 within computing device 200 may store information for processing during operation of computing device 200 (e.g., computing device 200 may store data accessed by authentication module 210, enrollment module 212, UI module 222, and OS 224 during execution at computing device 200). In some examples, storage device 208 may be a temporary memory, meaning that a primary purpose of storage device 208 is not long-term storage. Storage device 208 on computing device 200 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage device 208 may include one or more computer-readable storage media. Storage device 208 may be configured to store larger amounts of information than volatile memory. Storage device 208 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage device 208 may store program instructions and/or information (e.g., enrolled fingerprint repository 214, enrolled non-fingerprint repository 216, etc.) associated with authentication module 210, enrollment module 212, UI module 222, and OS 224.

Communication channels 248 (“COMM channel 248”) may interconnect each of the components 202, 204, 208, 242, 244, and 246 for inter-component communications (physically, communicatively, and/or operatively). In some examples, communication channels 248 may include a system bus, a network connection, an inter-process communication data structure, or any other method for communicating data.

Input component 242 of computing device 200 may receive input. Examples of input are tactile, audio, and video input. Input component 242 of computing device 200, in one example, includes a presence-sensitive display, such as presence-sensitive display 202, a fingerprint sensor, such as fingerprint sensor 206, touch-sensitive screen, mouse, keyboard, voice responsive system, video camera, microphone or any other type of device for detecting input from a human or machine. As discussed above, fingerprint sensor 206 may be located at any portion of computing device 200, such as a front portion, a side portion, a rear portion, etc. In examples where fingerprint sensor 206 is located at the front portion, fingerprint sensor 206 may be a UDFS, a through-display sensor, etc. For example, fingerprint sensor 206 may be positioned underneath one or more layers of presence-sensitive display 202. Fingerprint sensor 206 may be configured to sense a fingerprint through presence-sensitive display 202. In examples where fingerprint sensor 206 is located at a side portion, fingerprint sensor 206 may be part of a solid-state button.

Input component 242 may include one or more sensors. Numerous examples of sensors exist and include any input component configured to obtain environmental information about the circumstances surrounding computing device 200 and/or physiological information that defines the activity state and/or physical well-being of a user of computing device 200. In some examples, a sensor may be an input component that obtains physical position, movement, and/or location information of computing device 200. For instance, sensors may include one or more location sensors (e.g., GNSS components. Wi-Fi components, cellular components), one or more temperature sensors, one or more motion sensors (e.g., multi-axial accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

Communication unit 244 of computing device 200 may communicate with one or more external devices via one or more wired and/or wireless networks by transmitting and/or receiving network signals on the one or more networks. Examples of communication units 244 include a network interface card (e.g. such as an Ethernet card), an optical transceiver, a radio frequency transceiver, a GPS receiver, or any other type of device that can send and/or receive information. Other examples of communication unit 244 may include short wave radios, cellular data radios, wireless network radios, as well as universal serial bus (USB) controllers.

Output component 246 of computing device 200 may generate one or more outputs. Examples of outputs are tactile, audio, and video output. Output component 246 of computing device 200, in one example, includes a presence-sensitive display, sound card, video graphics adapter card, speaker, liquid crystal display (LCD), or any other type of device for generating output to a human or machine.

OS 224, or a component thereof, may manage interactions between applications and a user of computing device 200. In some examples, UI module 222 may be considered a component of OS 224.

As noted above, computing device 200 may use the fingerprint information in enrolled fingerprint repository 214 and enrolled non-fingerprint repository 216 for future fingerprint authentication attempts. For example, before computing device 200 has authenticated the user of computing device 200 (e.g., while computing device is in a locked mode), fingerprint sensor 206 may detect a current touch input by the user, initiating a fingerprint authentication attempt. While detecting the current touch input, fingerprint sensor 206 may capture or otherwise generate current fingerprint information representative of the current touch input.

Authentication module 210 may determine whether the current fingerprint information captured by fingerprint sensor 206 corresponds to (e.g., matches) any enrolled fingerprint from the set of enrolled fingerprints stored in enrolled fingerprint repository 214 or any enrolled non-fingerprint from the set of enrolled non-fingerprints stored in enrolled non-fingerprint repository 216. In some examples, authentication module 210 may determine correspondence of the current fingerprint information by comparing the captured image representative of the current touch input to any enrolled fingerprint from the set of enrolled fingerprints or any enrolled non-fingerprint from the set of enrolled non-fingerprints.

Additionally or alternatively, authentication module 210 may use a machine learning algorithm to determine correspondence of the current fingerprint information. For instance, the machine learning algorithm may perform classification in which the machine learning algorithm provides a numerical value descriptive of a degree to which it is believed that the current fingerprint information should be classified into a “match” class or a “not match” class with respect to any enrolled fingerprint from the set of enrolled fingerprints or any enrolled non-fingerprint from the set of enrolled non-fingerprints. In some instances, the numerical values provided by the machine learning algorithm may be referred to as “confidence scores” that are indicative of a respective confidence associated with classification of the input into the respective class. In some examples, the confidence scores can be compared to one or more thresholds to render a discrete categorical prediction. In some examples, only a certain number of classes (e.g., one) with the relatively largest confidence scores may be selected to render a discrete categorical prediction.

In any case, authentication module 210 may selectively authenticate a user based on the correspondence of the current fingerprint information. For example, responsive to authentication module 210 determining that the current fingerprint information does not correspond to any enrolled fingerprint from the set of enrolled fingerprints or any enrolled non-fingerprint from the set of enrolled non-fingerprints, authentication module 210 may classify the current touch input as an unsuccessful intended fingerprint authentication attempt. In addition, authentication module 210 may deny authentication based on the unsuccessful intended fingerprint authentication attempt. In some examples, authentication module 210 may deny, for a lockout period of time (e.g., 1 minute, 5 minutes, etc.), authentication for all authentication attempts in response to a number of unsuccessful intended fingerprint authentication attempts satisfying a threshold number of unsuccessful intended fingerprint authentication attempts (e.g., 3 attempts, 5 attempts, 10 attempts, etc.).

In another example, responsive to authentication module 210 determining that the current fingerprint information corresponds to any enrolled fingerprint from the set of enrolled fingerprints, authentication module 210 may authenticate the user of computing device 200 as the owner of computing device 200. In turn, OS 224 may perform an unlock operation or may otherwise provide the user with access to applications installed at computing device 200. In some examples, authentication module 210 may be considered a component of OS 224.

In yet another example, responsive to authentication module 210 determining that the current fingerprint information corresponds to any enrolled non-fingerprint from the set of non-enrolled fingerprints, authentication module 210 may classify the current touch input as an unintended fingerprint authentication attempt. Authentication module 210 may deny authentication based on the unintended fingerprint authentication attempt but not implement any authentication safeguards for the unintended fingerprint authentication attempt. Alternatively, authentication module 210 may authenticate the user of computing device 200 as the owner of computing device 200, and OS 224 may perform an unlock operation or may otherwise provide the user with access to applications installed at computing device 200.

Storage device 208 may store UI module 222. UI module 222 may manage user interactions with presence-sensitive display 202 and other components of computing device 200. For example, UI module 222 may output a UI and may cause presence-sensitive display 202 to display the UI as a user of computing device 200 views output and/or provides input at presence-sensitive display 202 or other components of computing device 200. For example, UI module 222 may output, for display by presence-sensitive display 202, a graphical user interface (GUI) including an indication of a suggested hand portion (e.g., a fingerprint portion, a non-fingerprint portion, etc.) for enrollment.

Enrollment module 212 may store fingerprint information in enrolled fingerprint repository 214 or enrolled non-fingerprint repository 216 at least partially based on whether the suggested hand portion included in the GUI is a fingerprint portion or a non-fingerprint portion. That is, in some examples, enrollment module 212 may store fingerprint information as an enrolled fingerprint in enrolled fingerprint repository 214 at least partially based on the suggested hand portion being a fingerprint portion. Similarly, enrollment module 212 may store fingerprint information as a non-enrolled fingerprint in enrolled non-fingerprint repository 216 at least partially based on the suggested hand portion being a non-fingerprint portion.

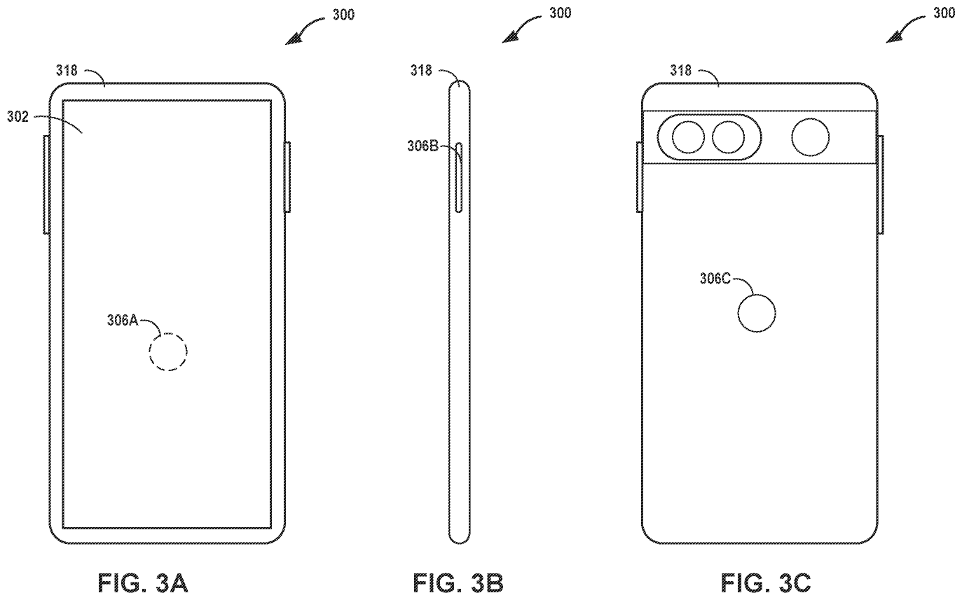

FIGS. 3A-3C are conceptual diagrams of various perspectives of a computing device 300 in accordance with one or more techniques of this disclosure. Computing device 300 of FIGS. 3A-3C may be an example of computing device 100 illustrated in FIG. 1 and/or computing device 200 illustrated in FIG. 2.

FIG. 3A shows a front portion of a housing 318 of computing device 300. The front portion of housing 318 may include a presence-sensitive display 302. In addition, the front portion of housing 318 may include a fingerprint sensor 306A. Fingerprint sensor 306A may be a through-display fingerprint sensor.

FIG. 3B shows a side portion of housing 318 of computing device 300. The side portion of housing 318 may be disposed beside the front portion of housing 318. For example, the side portion of housing 318 may include a top side, a bottom side, a left side, and a right side of housing 318. The side portion of housing 318 may include a fingerprint sensor 306B. Fingerprint sensor 306B may be a solid-state button. Fingerprint sensor 306B may be disposed at any location of the side portion of housing 318, such as a top side, a bottom side, a left side, and/or a right side of housing 318.

FIG. 3C shows a rear portion of housing 318 of computing device 300. The rear portion of housing 318 may be disposed opposite the front portion of housing 318. The rear portion of housing 318 may include a fingerprint sensor 306C.

Although fingerprint sensors 306A-306C are illustrated as being disposed at specific locations of respective portions of housing 318 of computing device 300, it should be understood that a fingerprint sensor in accordance with techniques of this disclosure may be disposed at any location of any portion of housing 318. Furthermore, the fingerprint sensor may be any fingerprint sensor configured to detect a touch input and capture fingerprint information in accordance with techniques of this disclosure. Thus, examples of the fingerprint sensor may include fingerprint sensors that are buttons and fingerprint sensors that are not buttons. Other examples of fingerprint sensors are contemplated by this disclosure.

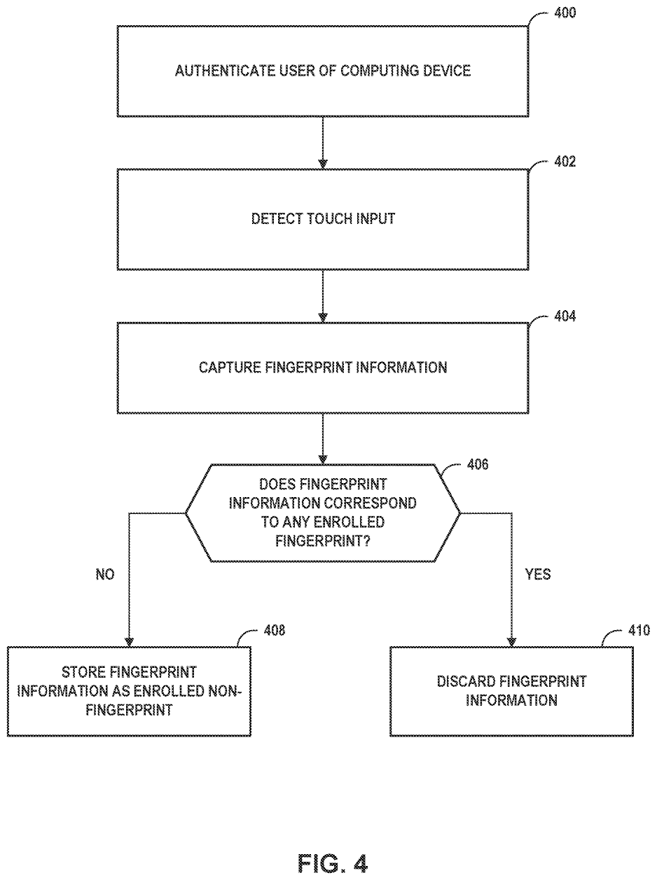

FIG. 4 is a flowchart illustrating example operations of an example computing device in accordance with one or more aspects of the present disclosure. Although the example operation of FIG. 4 is described as being performed by computing device 200 of FIG. 2, in other examples some or all of the example operation may be performed by another computing device.

Authentication module 210 of computing device 200 may authenticate a user of computing device 200 (400). Authentication module 210 may authenticate the user of computing device 200 before computing device 200 enrolling non-fingerprint portions to, for example, confirm that the user currently operating computing device 200 is the owner of computing device 200.

After authentication module 210 has authenticated the user of computing device 200, fingerprint sensor 206 may detect a touch input (e.g., touch input 120) by the user (402). While detecting the touch input, fingerprint sensor 206 may capture or otherwise generate fingerprint information representative of the touch input (404). In general, the touch input may be by a fingerprint portion or a non-fingerprint portion of a user's hand. Fingerprint information captured by fingerprint sensor 206 may include information representative of a fingerprint portion or information representative of a non-fingerprint portion depending on the portion of the user's body detected by fingerprint sensor 206.

Enrollment module 212 may obtain the fingerprint information captured by fingerprint sensor 206. In some examples, the user may need to provide the touch input to fingerprint sensor 206 within a predetermined period of time (e.g., 5 seconds, 15 seconds, 30 seconds, etc.) of authentication module 210 authenticating the user for enrollment module 212 to obtain the fingerprint information. This condition involving a user providing touch input 120 within a predetermined period of time may ensure that enrollment module 212 enrolls non-fingerprint portions of the hand of the recently authenticated user (e.g., the owner) of computing device 200 and not someone else's hand.

Enrollment module 212 may determine whether the fingerprint information captured by fingerprint sensor 206 corresponds to (e.g., matches) any enrolled fingerprint from a set of enrolled fingerprints stored in enrolled fingerprint repository 214 (406). Responsive to determining that the fingerprint information does not correspond to any enrolled fingerprint from the set of enrolled fingerprints (“NO” branch of 406), enrollment module 212 may determine that the fingerprint information includes information representative of a non-fingerprint portion and accordingly store the fingerprint information in enrolled non-fingerprint repository 216 as an enrolled non-fingerprint (408).

In some examples, responsive to determining that the fingerprint information does not correspond to any enrolled fingerprint from the set of enrolled fingerprints (“NO” branch of 406), enrollment module 212 may determine whether the fingerprint information corresponds to any enrolled non-fingerprint in enrolled non-fingerprint repository 216. Responsive to determining that the fingerprint information does not correspond to any enrolled non-fingerprint in enrolled non-fingerprint repository 216, enrollment module 212 may store the fingerprint information in enrolled non-fingerprint repository 216 as an enrolled non-fingerprint (408). Responsive to determining that the fingerprint information corresponds to any enrolled non-fingerprint in enrolled non-fingerprint repository 216, enrollment module 212 may update enrolled non-fingerprint repository 216 (e.g., by replacing the corresponding enrolled non-fingerprint in enrolled non-fingerprint repository 216) or discard the fingerprint information.

Responsive to determining that the fingerprint information does correspond to any enrolled fingerprint from the set of enrolled fingerprints (“YES” branch of 406), enrollment module 212 may discard the fingerprint information (410). In some examples, instead of discarding the fingerprint information, enrollment module 212 may update enrolled fingerprint repository 214 (e.g., by replacing the corresponding enrolled fingerprint in enrolled fingerprint repository 214). Updating enrolled fingerprint repository 214 and enrolled non-fingerprint repository 216 as described above may help conserve memory of computing device 200. Discarding fingerprint information may similarly help conserve memory of computing device 200.

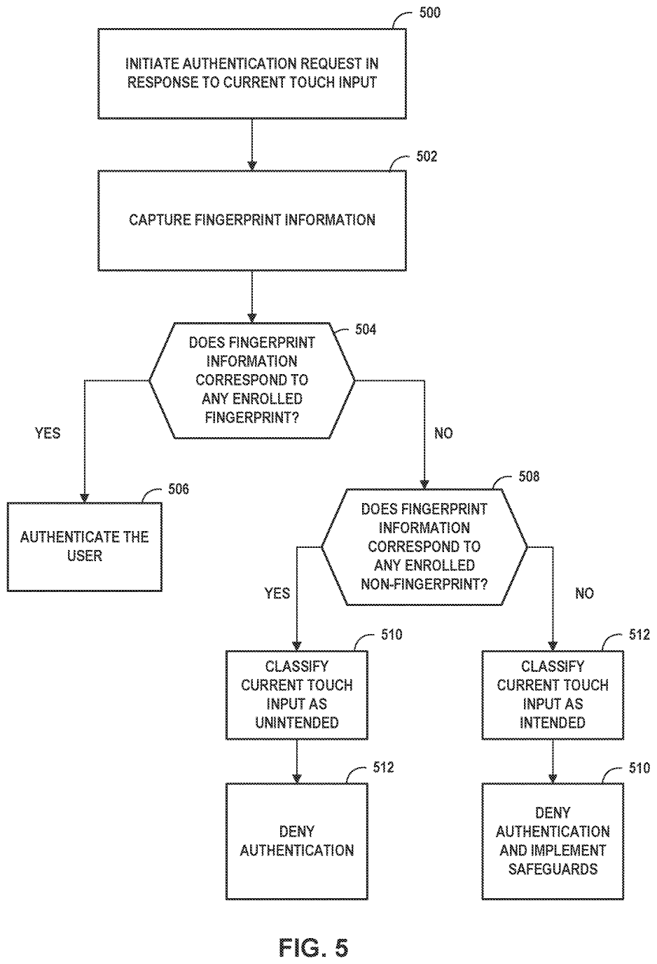

FIG. 5 is a flowchart illustrating example operations of an example computing device in accordance with one or more aspects of the present disclosure. Although the example operation of FIG. 5 is described as being performed by computing device 200 of FIG. 2, in other examples some or all of the example operation may be performed by another computing device.

In some examples, fingerprint sensor 206 may detect a current touch input by the user, initiating a fingerprint authentication attempt (500). While detecting the current touch input, fingerprint sensor 206 may capture or otherwise generate current fingerprint information representative of the current touch input (502).

Authentication module 210 may determine whether the current fingerprint information captured by fingerprint sensor 206 corresponds to (e.g., matches) any enrolled fingerprint from the set of enrolled fingerprints stored in enrolled fingerprint repository 214 (504). Responsive to authentication module 210 determining that the current fingerprint information corresponds to any enrolled fingerprint from the set of enrolled fingerprints (“YES” branch of 504), authentication module 210 may authenticate the user of computing device 200 as the owner of computing device 200 (506). In turn, OS 224 may perform an unlock operation or may otherwise provide the user with access to applications installed at computing device 200.

Responsive to authentication module 210 determining that the current fingerprint information does not correspond to any enrolled fingerprint from the set of enrolled fingerprints (“NO” branch of 504), authentication module 210 may determine whether the current fingerprint information captured by fingerprint sensor 206 corresponds to any enrolled non-fingerprint from the set of enrolled non-fingerprints stored in enrolled non-fingerprint repository 216 (508).

Responsive to authentication module 210 determining that the current fingerprint information corresponds to any enrolled non-fingerprint from the set of non-enrolled fingerprints (“YES” branch of 508), authentication module 210 may classify the current touch input as an unintended fingerprint authentication attempt (510). Authentication module 210 may deny authentication based on the unintended fingerprint authentication attempt but not implement any authentication safeguards based on the unintended fingerprint authentication attempt (512).

Responsive to authentication module 210 determining that the current fingerprint information does not correspond to any enrolled non-fingerprint from the set of non-enrolled fingerprints (“NO” branch of 508), authentication module 210 may classify the current touch input as an intended fingerprint authentication attempt (510). Authentication module 210 may deny authentication based on the intended fingerprint authentication attempt and implement one or more authentication safeguards based on the intended fingerprint authentication attempt (512). In some examples, authentication module 210 may deny, for a lockout period of time (e.g., 1 minute, 5 minutes, etc.), authentication for all authentication attempts in response to a number of unsuccessful intended fingerprint authentication attempts satisfying a threshold number of unsuccessful intended fingerprint authentication attempts (e.g., 3 attempts, 5 attempts, 10 attempts, etc.).

Aspects of this disclosure include the following examples.

Example 1: A method includes authenticating, by a computing device, a user of the computing device; detecting, by a fingerprint sensor of the computing device, a touch input provided within a predetermined period of time of the computing device authenticating the user; while detecting the touch input, capturing, by the fingerprint sensor, fingerprint information; determining, by the computing device, whether the fingerprint information corresponds to any enrolled fingerprint from a set of enrolled fingerprints stored at the computing device; and responsive to determining that the fingerprint information does not correspond to any enrolled fingerprint from the set of enrolled fingerprints, storing, by the computing device, the fingerprint information as an enrolled non-fingerprint.

Example 2: The method of example 1, wherein the touch input is a first touch input, wherein the fingerprint information is a first fingerprint information, and wherein the method further includes: detecting, by the fingerprint sensor of the computing device, a second touch input; while detecting the second touch input, obtaining, by the fingerprint sensor, second fingerprint information; determining, by the computing device, whether the second fingerprint information corresponds to any enrolled fingerprint from the set of enrolled fingerprints; and responsive to determining that the second fingerprint information corresponds to any enrolled fingerprint from the set of enrolled fingerprints, discarding, by the computing device, the second fingerprint information.

Example 3: The method of any of examples 1 through 2, wherein the touch input is a first touch input, wherein the fingerprint information is a first fingerprint information, and wherein the method further includes: detecting, by the fingerprint sensor of the computing device, a second touch input within the predetermined period of time of the computing device authenticating the user; while detecting the second touch input, obtaining, by the fingerprint sensor, second fingerprint information; and determining, by the computing device, whether the second fingerprint information corresponds to any enrolled fingerprint from the set of enrolled fingerprints or any enrolled non-fingerprint from a set of enrolled non-fingerprints.

Example 4: The method of example 3, further includes responsive to determining that the second fingerprint information does not correspond to any enrolled fingerprint from the set of enrolled fingerprints or any enrolled non-fingerprint from the set of enrolled non-fingerprints, classifying, by the computing device, the second touch input as an unsuccessful intended fingerprint authentication attempt.

Example 5: The method of example 4, further including denying authentication based on the unsuccessful intended fingerprint authentication attempt.

Example 6: The method of example 4 or 5, further including denying, for a lockout period of time, authentication for all authentication attempts in response to a number of unsuccessful intended fingerprint authentication attempts satisfying a threshold number of unsuccessful intended fingerprint authentication attempts.

Example 7: The method of example 3, further includes responsive to determining that the second fingerprint information corresponds to any enrolled fingerprint from the set of enrolled fingerprints, authenticating, by the computing device, the user of the computing device.

Example 8: The method of example 3, further includes responsive to determining that the second fingerprint information corresponds to any enrolled non-fingerprint from the set of enrolled non-fingerprints, classifying, by the computing device, the second touch input as an unintended fingerprint authentication attempt.

Example 9: The method of any of examples 1 through 8, further includes outputting, by the computing device and for display by a presence-sensitive display, a graphical user interface including an indication of a suggested hand portion for enrollment, wherein storing the fingerprint information as the enrolled non-fingerprint is at least partially based on the suggested hand portion being a non-fingerprint portion.

Example 10: The method of any of examples 1 through 9, wherein the fingerprint sensor is located on a side portion or a rear portion of a housing of the computing device, wherein the side portion is disposed beside a front portion of the housing, wherein the rear portion is disposed opposite a front portion of the housing, and wherein the front portion of the housing includes a presence-sensitive display.

Example 11: The method of any of examples 1 through 10, wherein the fingerprint sensor is a through-display fingerprint sensor.

Example 12: The method of any of examples 1 through 11, wherein authenticating the user of the computing device includes using at least one of a password, an identifying number, fingerprint recognition, or facial recognition.

Example 13: The method of any of examples 1 through 12, wherein the touch input is by a proximal phalanx or an intermediate phalanx of a finger.

Example 14: A computing device includes a fingerprint sensor; one or more processors; a first memory configured to store fingerprint information; and a second memory that stores instructions that, when executed by the one or more processors, cause the one or more processors to: authenticate a user of the computing device; determine whether a touch input was detected by the fingerprint sensor within a predetermined period of time of the computing device authenticating the user; responsive to determining that the touch input was detected, determine whether fingerprint information captured by the fingerprint sensor while the fingerprint sensor detected the touch input corresponds to any enrolled fingerprint from a set of enrolled fingerprints stored in the first memory of the computing device; and responsive to determining that the fingerprint information does not correspond to any enrolled fingerprint from the set of enrolled fingerprints, store in the first memory of the computing device the fingerprint information as an enrolled non-fingerprint.

Example 15: The computing device of example 14, wherein the touch input is a first touch input, wherein the fingerprint information is a first fingerprint information, and wherein the instructions further cause the one or more processors to: determine whether a second touch input was detected by the fingerprint sensor; responsive to determining that the second touch input was detected, determine whether a second fingerprint information captured by the fingerprint sensor while the fingerprint sensor detected the second touch input corresponds to any enrolled fingerprint from the set of enrolled fingerprints; and responsive to determining that the fingerprint information corresponds to any enrolled fingerprint from the set of enrolled fingerprints, discard the second fingerprint information.

Example 16: The computing device of any of examples 14 through 15, wherein the touch input is a first touch input, wherein the fingerprint information is a first fingerprint information, and wherein the instructions further cause the one or more processors to: determine whether a second touch input was detected by the fingerprint sensor within the predetermined period of time of the computing device authenticating the user; responsive to determining that the second touch input was detected, determine whether a second fingerprint information captured by the fingerprint sensor while the fingerprint sensor detected the second touch input corresponds to any enrolled fingerprint from the set of enrolled fingerprints or any enrolled non-fingerprint from a set of enrolled non-fingerprints.

Example 17: The computing device of example 16, wherein the instructions further cause the one or more processors to: responsive to determining that the second fingerprint information does not correspond to any enrolled fingerprint from the set of enrolled fingerprints or any enrolled non-fingerprint from the set of enrolled non-fingerprints, classify the second touch input as an unsuccessful intended fingerprint authentication attempt.

Example 18: The computing device of example 17, wherein the instructions further cause the one or more processors to deny authentication based on the unsuccessful intended fingerprint authentication attempt.

Example 19: The computing device of example 17 or 18, wherein the instructions further cause the one or more processors to deny, for a lockout period of time, authentication for all authentication attempts in response to a number of unsuccessful intended fingerprint authentication attempts satisfying a threshold number of unsuccessful intended fingerprint authentication attempts.

Example 20: The computing device of example 16, wherein the instructions further cause the one or more processors to: responsive to determining that the second fingerprint information corresponds to any enrolled fingerprint from the set of enrolled fingerprints, authenticate the user of the computing device.

Example 21: The computing device of example 16, further includes responsive to determining that the second fingerprint information corresponds to any enrolled non-fingerprint from the set of enrolled non-fingerprints, classify the second touch input as an unintended fingerprint authentication attempt.

Example 22: The computing device of any of examples 14 through 21, wherein the instructions further cause the one or more processors to: output, for display by a presence-sensitive display, a graphical user interface including an indication of a suggested hand portion for enrollment, wherein the one or more processors store the fingerprint information as the enrolled non-fingerprint at least partially based on the suggested hand portion being a non-fingerprint portion.

Example 23: The computing device of any of examples 14 through 22, wherein the fingerprint sensor is located on a side portion or a rear portion of a housing of the computing device, wherein the side portion is disposed beside a front portion of the housing, wherein the rear portion is disposed opposite a front portion of the housing, and wherein the front portion of the housing includes a presence-sensitive display.

Example 24: The computing device of any of examples 14 through 23, wherein the fingerprint sensor is a through-display fingerprint sensor.

Example 25: The computing device of any of examples 14 through 24, wherein the one or more processors authenticate the user of the computing device by using at least one of a password, an identifying number, fingerprint recognition, or facial recognition.

Example 26: The computing device of any of examples 14 through 25, wherein the touch input is by a proximal phalanx or an intermediate phalanx of a finger.

Example 27: A non-transitory computer-readable storage medium stores instructions that, when executed, cause one or more processors of a computing device to: authenticate a user of the computing device; determine whether a touch input was detected by the fingerprint sensor within a predetermined period of time of the computing device authenticating the user; responsive to determining that the touch input was detected, determine whether fingerprint information captured by the fingerprint sensor while the fingerprint sensor detected the touch input corresponds to any enrolled fingerprint from a set of enrolled fingerprints stored in a memory of the computing device; and responsive to determining that the fingerprint information does not correspond to any enrolled fingerprint from the set of enrolled fingerprints, store in the memory of the computing device the fingerprint information as an enrolled non-fingerprint.

Example 28: The computing device of example 27, wherein the touch input is a first touch input, wherein the fingerprint information is a first fingerprint information, and wherein the instructions further cause the one or more processors to: determine whether a second touch input was detected by the fingerprint sensor; responsive to determining that the second touch input was detected, determine whether a second fingerprint information captured by the fingerprint sensor while the fingerprint sensor detected the second touch input corresponds to any enrolled fingerprint from the set of enrolled fingerprints; and responsive to determining that the fingerprint information corresponds to any enrolled fingerprint from the set of enrolled fingerprints, discard the second fingerprint information.

Example 29: The computing device of any of examples 27 through 28, wherein the touch input is a first touch input, wherein the fingerprint information is a first fingerprint information, and wherein the instructions further cause the one or more processors to: determine whether a second touch input was detected by the fingerprint sensor within the predetermined period of time of the computing device authenticating the user; responsive to determining that the second touch input was detected, determine whether a second fingerprint information captured by the fingerprint sensor while the fingerprint sensor detected the second touch input corresponds to any enrolled fingerprint from the set of enrolled fingerprints or any enrolled non-fingerprint from a set of enrolled non-fingerprints.

Example 30: The computing device of example 29, wherein the instructions further cause the one or more processors to: responsive to determining that the second fingerprint information does not correspond to any enrolled fingerprint from the set of enrolled fingerprints or any enrolled non-fingerprint from the set of enrolled non-fingerprints, classify the second touch input as an unsuccessful intended fingerprint authentication attempt.

Example 31: The computing device of example 30, wherein the instructions further cause the one or more processors to deny authentication based on the unsuccessful intended fingerprint authentication attempt.

Example 32: The computing device of example 30 or 31, wherein the instructions further cause the one or more processors to deny, for a lockout period of time, authentication for all authentication attempts in response to a number of unsuccessful intended fingerprint authentication attempts satisfying a threshold number of unsuccessful intended fingerprint authentication attempts.

Example 33: The computing device of example 29, wherein the instructions further cause the one or more processors to: responsive to determining that the second fingerprint information corresponds to any enrolled fingerprint from the set of enrolled fingerprints, authenticate the user of the computing device.

Example 34: The computing device of example 29, further includes responsive to determining that the second fingerprint information corresponds to any enrolled non-fingerprint from the set of enrolled non-fingerprints, classify the second touch input as an unintended fingerprint authentication attempt.

Example 35: The computing device of any of examples 27 through 34, wherein the instructions further cause the one or more processors to: output, for display by a presence-sensitive display, a graphical user interface including an indication of a suggested hand portion for enrollment, wherein the one or more processors store the fingerprint information as the enrolled non-fingerprint at least partially based on the suggested hand portion being a non-fingerprint portion.

Example 36: The computing device of any of examples 27 through 35, wherein the fingerprint sensor is located on a side portion or a rear portion of a housing of the computing device, wherein the side portion is disposed beside a front portion of the housing, wherein the rear portion is disposed opposite a front portion of the housing, and wherein the front portion of the housing includes a presence-sensitive display.

Example 37: The computing device of any of examples 27 through 36, wherein the fingerprint sensor is a through-display fingerprint sensor.

Example 38: The computing device of any of examples 27 through 37, wherein the one or more processors authenticate the user of the computing device by using at least one of a password, an identifying number, fingerprint recognition, or facial recognition.

Example 39: The computing device of any of examples 27 through 38, wherein the touch input is by a proximal phalanx or an intermediate phalanx of a finger.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1. A method comprising:
authenticating, by a computing device, a user of the computing device;
detecting, by a fingerprint sensor of the computing device, a touch input provided within a predetermined period of time of the computing device authenticating the user;
while detecting the touch input, capturing, by the fingerprint sensor, fingerprint information;
determining, by the computing device, whether the fingerprint information corresponds to any enrolled fingerprint from a set of enrolled fingerprints stored at the computing device; and
responsive to determining that the fingerprint information does not correspond to any enrolled fingerprint from the set of enrolled fingerprints, storing, by the computing device, the fingerprint information as an enrolled non-fingerprint.

2. The method of claim 1, wherein the touch input is a first touch input, wherein the fingerprint information is a first fingerprint information, and wherein the method further comprises:
detecting, by the fingerprint sensor of the computing device, a second touch input;
while detecting the second touch input, obtaining, by the fingerprint sensor, second fingerprint information;
determining, by the computing device, whether the second fingerprint information corresponds to any enrolled fingerprint from the set of enrolled fingerprints; and
responsive to determining that the second fingerprint information corresponds to any enrolled fingerprint from the set of enrolled fingerprints, discarding, by the computing device, the second fingerprint information.

3. The method of claim 1, wherein the touch input is a first touch input, wherein the fingerprint information is a first fingerprint information, and wherein the method further comprises:
detecting, by the fingerprint sensor of the computing device, a second touch input provided within the predetermined period of time of the computing device authenticating the user;
while detecting the second touch input, obtaining, by the fingerprint sensor, second fingerprint information; and
determining, by the computing device, whether the second fingerprint information corresponds to any enrolled fingerprint from the set of enrolled fingerprints or any enrolled non-fingerprint from a set of enrolled non-fingerprints.

4. The method of claim 3, further comprising:
responsive to determining that the second fingerprint information does not correspond to any enrolled fingerprint from the set of enrolled fingerprints or any enrolled non-fingerprint from the set of enrolled non-fingerprints, classifying, by the computing device, the second touch input as an unsuccessful intended fingerprint authentication attempt.

5. The method of claim 4, further comprising denying authentication based on the unsuccessful intended fingerprint authentication attempt.

6. The method of claim 4, further comprising denying, for a lockout period of time, authentication for all authentication attempts in response to a number of unsuccessful intended fingerprint authentication attempts satisfying a threshold number of unsuccessful intended fingerprint authentication attempts.

7. The method of claim 3, further comprising: responsive to determining that the second fingerprint information corresponds to any enrolled fingerprint from the set of enrolled fingerprints, authenticating, by the computing device, the user of the computing device.

8. The method of claim 3, further comprising: responsive to determining that the second fingerprint information corresponds to any enrolled non-fingerprint from the set of enrolled non-fingerprints, classifying, by the computing device, the second touch input as an unintended fingerprint authentication attempt.

9. The method of claim 1, further comprising:
outputting, by the computing device and for display by a presence-sensitive display, a graphical user interface including an indication of a suggested hand portion for enrollment, wherein storing the fingerprint information as the enrolled non-fingerprint is at least partially based on the suggested hand portion being a non-fingerprint portion.

10. The method of claim 1, wherein the fingerprint sensor is located on a side portion or a rear portion of a housing of the computing device, wherein the side portion is disposed beside a front portion of the housing, wherein the rear portion is disposed opposite a front portion of the housing, and wherein the front portion of the housing comprises a presence-sensitive display.

11. The method of claim 1, wherein the fingerprint sensor is a through-display fingerprint sensor.

12. The method of claim 1, wherein authenticating the user of the computing device comprises using at least one of a password, an identifying number, fingerprint recognition, or facial recognition.

13. The method of claim 1, wherein the touch input is by a proximal phalanx or an intermediate phalanx of a finger.

14. (canceled)

15. A computer-readable storage medium comprising instructions that, when executed, cause one or more processors of a computing device to:
authenticate a user of the computing device;
determine whether a touch input was detected by the fingerprint sensor within a predetermined period of time of the computing device authenticating the user;
responsive to determining that the touch input was detected, determine whether fingerprint information captured by the fingerprint sensor while the fingerprint sensor detected the touch input corresponds to any enrolled fingerprint from a set of enrolled fingerprints stored in a memory of the computing device; and
responsive to determining that the fingerprint information does not correspond to any enrolled fingerprint from the set of enrolled fingerprints, store in the memory of the computing device the fingerprint information as an enrolled non-fingerprint.

16. A computing device comprising:
a fingerprint sensor;
one or more processors;
a first memory configured to store fingerprint information; and
a second memory that stores instructions that, when executed by the one or more processors, cause the one or more processors to:
authenticate a user of the computing device;
determine whether a touch input was detected by the fingerprint sensor within a predetermined period of time of the computing device authenticating the user;
responsive to determining that the touch input was detected, determine whether fingerprint information captured by the fingerprint sensor while the fingerprint sensor detected the touch input corresponds to any enrolled fingerprint from a set of enrolled fingerprints stored in the first memory of the computing device; and
responsive to determining that the fingerprint information does not correspond to any enrolled fingerprint from the set of enrolled fingerprints, store in the first memory of the computing device the fingerprint information as an enrolled non-fingerprint.

17. The computing device of claim 16, wherein the touch input is a first touch input, wherein the fingerprint information is a first fingerprint information, and wherein the instructions further cause the one or more processors to:
determine whether a second touch input was detected by the fingerprint sensor;
responsive to determining that the second touch input was detected, determine whether a second fingerprint information captured by the fingerprint sensor while the fingerprint sensor detected the second touch input corresponds to any enrolled fingerprint from the set of enrolled fingerprints; and
responsive to determining that the fingerprint information corresponds to any enrolled fingerprint from the set of enrolled fingerprints, discard the second fingerprint information.

18. The computing device of claim 16, wherein the touch input is a first touch input, wherein the fingerprint information is a first fingerprint information, and wherein the instructions further cause the one or more processors to:
determine whether a second touch input was detected by the fingerprint sensor within the predetermined period of time of the computing device authenticating the user;
responsive to determining that the second touch input was detected, determine whether a second fingerprint information captured by the fingerprint sensor while the fingerprint sensor detected the second touch input corresponds to any enrolled fingerprint from the set of enrolled fingerprints or any enrolled non-fingerprint from a set of enrolled non-fingerprints;
responsive to determining that the second fingerprint information does not correspond to any enrolled fingerprint from the set of enrolled fingerprints or any enrolled non-fingerprint from the set of enrolled non-fingerprints:
classify the second touch input as an unsuccessful intended fingerprint authentication attempt; and
deny authentication based on the unsuccessful intended fingerprint authentication attempt; and
responsive to determining that the second fingerprint information corresponds to any enrolled fingerprint from the set of enrolled fingerprints, authenticate the user of the computing device.

19. The computing device of claim 16, wherein the instructions further cause the one or more processors to:
output, for display by a presence-sensitive display, a graphical user interface including an indication of a suggested hand portion for enrollment, wherein the one or more processors store the fingerprint information as the enrolled non-fingerprint at least partially based on the suggested hand portion being a non-fingerprint portion.

20. The computing device of claim 16, wherein the fingerprint sensor is located on a side portion or a rear portion of a housing of the computing device, wherein the side portion is disposed beside a front portion of the housing, wherein the rear portion is disposed opposite a front portion of the housing, and wherein the front portion of the housing includes a presence-sensitive display.

21. The computing device of claim 16, wherein the one or more processors authenticate the user of the computing device by using at least one of a password, an identifying number, fingerprint recognition, or facial recognition.
